(19) United States
(12) Patent Application Publication
(10) Pub. No.: US 2026/0020088 A1
(43) Pub. Date: Jan. 15, 2026

(54) METHODS, ARCHITECTURES, APPARATUSES AND SYSTEMS FOR UTILIZING FLOW CONTROL FROM A RELAY WTRU IN MULTIPATH SIDELINK OPERATIONS

(71) Applicant: InterDigital Patent Holdings, Inc., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(21) Appl. No.: 19/115,835

(22) PCT Filed: Sep. 26, 2023
(86) PCT No.: PCT/US2023/033714

§ 371 Date: Mar. 27, 2025

Related U.S. Application Data
(60) Provisional application No. 63/410,302, filed on Sep. 27, 2022.

(51) Int. Cl. H04W 76/14; H04W 28/02; H04W 28/10; H04W 76/28; H04W 92/18

(52) U.S. Cl. CPC H04W 76/14; H04W 28/0278; H04W 28/10; H04W 76/28; H04W 92/18

(57) ABSTRACT

Procedures, methods, architectures, apparatuses, systems, devices, and computer program products for utilizing flow control from a relay wireless transmit/receive unit (WTRU) in multipath operation which includes sidelink communication with a remote WTRU. In a representative example, a relay WTRU may provide flow control information to a remote WTRU. The flow control information may be associated with remote WTRU actions. The remote WTRU may perform one or more actions based on the reception of the flow control information from the relay WTRU.

### CROSS-REFERENCE TO RELATED APPLICATIONS

This application claims the benefit of U.S. Provisional Patent Application No. 63/410,302 filed 27 Sep, 2022, the contents of which is incorporated herein by reference.

### TECHNICAL FIELD

The present disclosure is generally directed to the fields of communications, software and encoding, including, for example, to methods, architectures, apparatuses, systems directed to multipath sidelink (SL) operations, and more particularly to the utilization of flow control (FC) for a remote wireless transmit/receive unit (WTRU) and a relay WTRU which operate in multipath environments.

### BACKGROUND

Relaying via ProSe UE-to-Network relays was introduced in 3GPP Release 13 to extend network coverage to an out of coverage UE by using PC5 communications, otherwise referred to as device-to-device (D2D) communication, between an out of coverage UE and a UE-to-Network relay. Further, 3GPP releases have added additional enhancements to remote and relay WTRU devices. Further enhancements to multipath sidelink operation which consider conditions present at the relay WTRU would be beneficial.

### SUMMARY

In a representative embodiment, a remote WTRU may receive, from a base station, configuration information for handling of data transmission over a direct link (Uu) and a SL. For example, the configuration information may include information indicating an association of (e.g., a set of) FC information with a distribution percentage (e.g., a set of distribution percentages) of data over the Uu and the SL. The remote WTRU may receive, from a relay WTRU, (e.g., specific) FC information. The remote WTRU may transmit, based on the distribution percentage associated with the received FC information, data using the Uu and the SL. The remote WTRU may transmit, to the base station, information indicating that transmission behavior of the remote WTRU has been modified (e.g., based on the FC information).

In another representative embodiment, a relay WTRU may determine whether one or more triggering conditions are satisfied. The relay WTRU may transmit, to a remote WTRU, FC information based on the one or more triggering conditions being satisfied. After transmitting the FC information, the relay WTRU may relay data received from the remote WTRU using the SL to a base station. For example, the remote WTRU may have modified its usage of the SL based on the FC information transmitted by the relay WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a Layer 2 (L2) user equipment-to-network (U2N) Relay architecture diagram illustrating an example of user plane protocol stacks;

FIG. 3 is a L2 U2N Relay architecture diagram illustrating an example of control plane protocol stacks;

FIG. 4 is an architecture diagram illustrating an example protocol view of a split bearer;

FIG. 5 is an architecture diagram illustrating an example protocol view of a split bearer in a case of multipath operation;

FIG. 6 is a system diagram illustrating an example multipath scenario;

FIG. 7 is a system diagram illustrating an example of signaling to enable certain representative embodiments;

FIG. 8 is a procedural diagram illustrating an example procedure for flow control at a remote WTRU;

FIG. 9 is a procedural diagram illustrating an example procedure for enabling flow control by a relay WTRU; and

FIG. 10 is a procedural diagram illustrating another example procedure for flow control at a remote WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

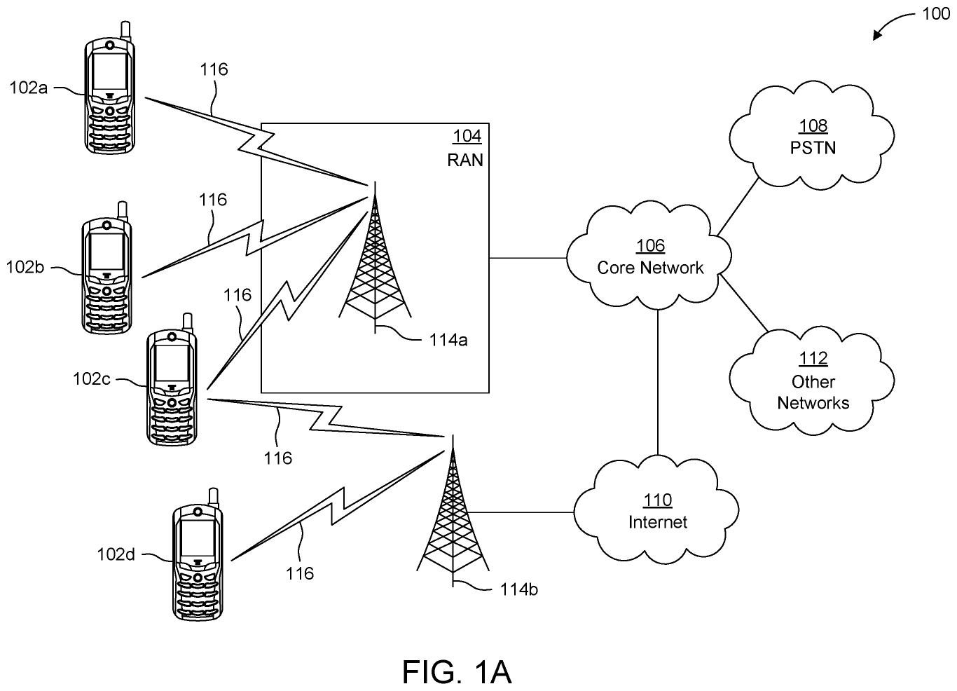

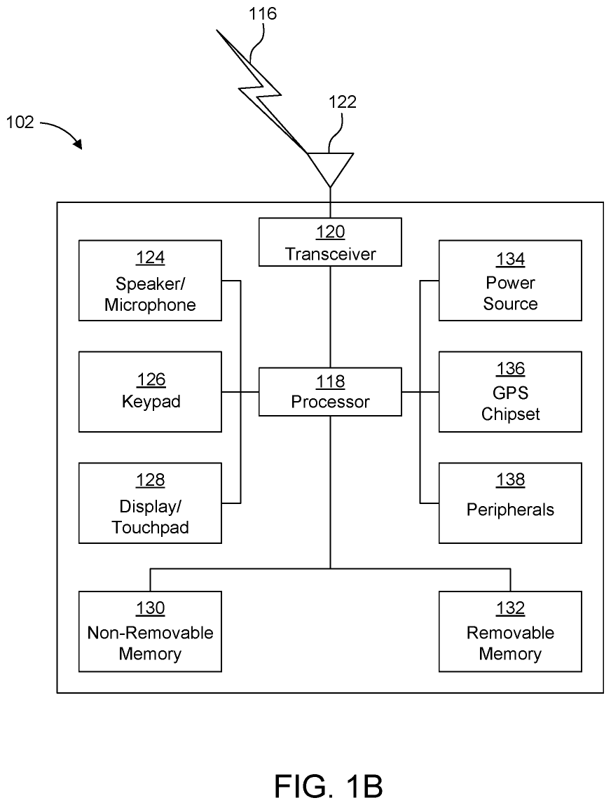

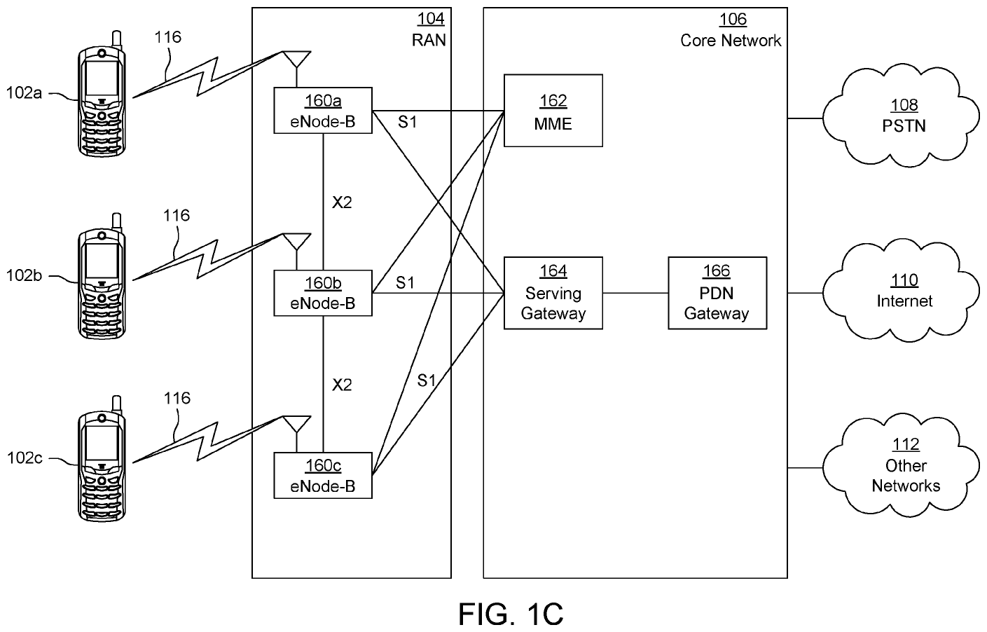

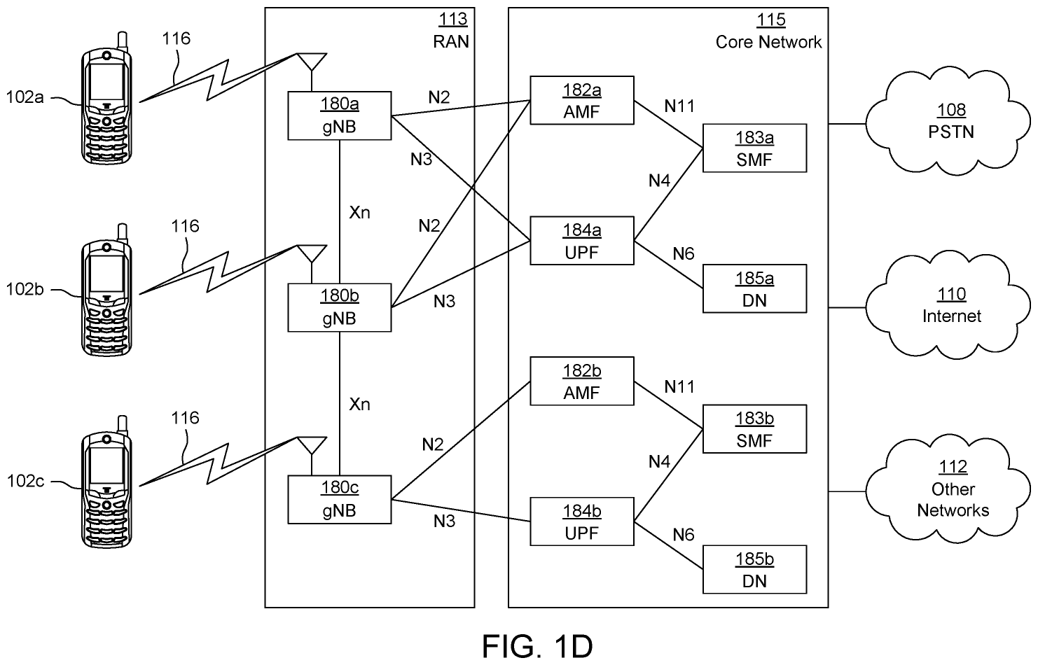

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WIMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHZ, 40 MHz, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Sidelink Operation

### WTRU-to-Network Relays

### Sidelink Relaying in Earlier Releases

Relaying via Proximity Services (ProSe) WTRU-to-Network relays was introduced in 3GPP Release 13 to extend network coverage to an out of coverage WTRU by using PC5 (D2D) between an out of coverage WTRU and a WTRU-to-Network relay. Particularly, TS 36.300 V15.4.0 states:

“A ProSe UE-to-Network Relay provides a generic L3 forwarding function that can relay any type of IP traffic between the Remote UE and the network. One-to-one and one-to-many sidelink communications are used between the Remote UE(s) and the ProSe UE-to-Network Relay. For both Remote UE and Relay UE only one single carrier (i.e., Public Safety ProSe Carrier) operation is supported (i.e., Uu and PC5 should be same carrier for Relay/Remote UE). The Remote UE is authorized by upper layers and can be in-coverage of the Public Safety ProSe Carrier or out-of-coverage on any supported carriers including Public Safety ProSe Carrier for UE-to-Network Relay discovery, (re) selection and communication. The ProSe UE-to-Network Relay is always in-coverage of EUTRAN”.

For 3GPP Release 16, a first version of NR sidelink has been developed, and it solely focuses on supporting V2X (Vehicle-to-Anything) related road safety services. The design aims to provide support for broadcast, groupcast and unicast communications in both out-of-coverage and in-network coverage scenarios. Additionally, sidelink-based relaying functionality should be additionally studied in order for sidelink/network coverage extension and power efficiency improvement, considering wider range of applications and services.

Further exploration of coverage extension for sidelink-based communication was proposed. For example, as to WTRU-to-network coverage extension, Uu coverage reachability is necessary for WTRUs to reach a server in a PDN network or a counterpart WTRU out of proximity area. However, the Release 13 solution on WTRU-to-network relays is limited to EUTRA-based technology, and thus cannot be applied to NR-based systems for both NG-RAN and NR-based sidelink communication. For example, as to WTRU-to-WTRU coverage extension, at the time of Release 16, proximity reachability was limited to single-hop sidelink link, either via EUTRA-based or NR-based sidelink technology. However, that is not sufficient in the scenario where there is no Uu coverage, considering the limited single-hop sidelink coverage.

Sidelink connectivity was further extended in the NR framework in order to support the enhanced QoS requirements.

### Sidelink Relaying in Release 17

3GPP Release 17 introduced single hop NR sidelink relays with the following main objectives, as discussed in RP-193253.

Study mechanism(s) with minimum specification impact to support the SA requirements for sidelink-based WTRU-to-network and WTRU-to-WTRU relay, focused on the following aspects (if applicable) for layer-3 relay and layer-2 relay [RAN2]:
Relay (re-)selection criterion and procedure;
Relay/Remote WTRU authorization;
QoS for relaying functionality;
Service continuity;
Security of relayed connection after SA3 has provided its conclusions; and
Impact on user plane protocol stack and control plane procedure, e.g., connection management of relayed connection.

Study mechanism(s) to support upper layer operations of discovery model/procedure for sidelink relaying, assuming no new physical layer channel/signal.

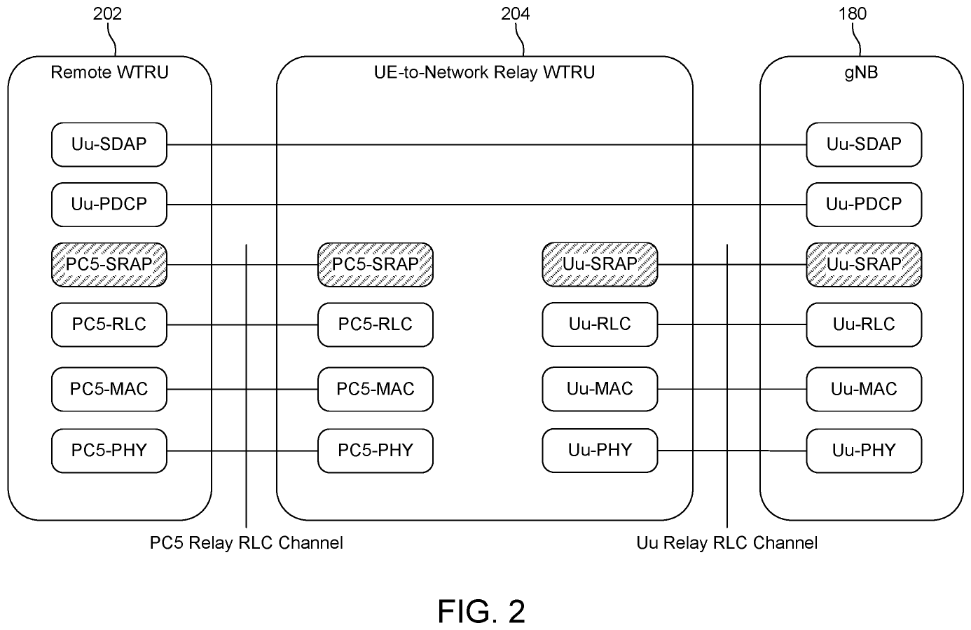

FIG. 2 is a L2 U2N Relay architecture diagram illustrating an example of user plane protocol stacks. A remote WTRU 202 may have a protocol stack which includes a Uu-SDAP sublayer and a Uu-PDCP sublayer which correspond with a Uu-SDAP sublayer and a Uu-PDCP sublayer of a gNB 180. The protocol stack at the remote WTRU 202 may also include a PC5-SRAP sublayer, a PC5-RLC sublayer, a PC5-MAC sublayer, and a PC5-PHY sublayer which correspond with a PC5-SRAP sublayer, a PC5-RLC sublayer, a PC5-MAC sublayer, and a PC5-PHY sublayer of a U2N relay WTRU 204. The protocol stack at the U2N relay WTRU 204 may also include a Uu-SRAP sublayer, a Uu-RLC sublayer, a Uu-MAC sublayer, and a Uu-PHY sublayer which correspond with a Uu-SRAP sublayer, a Uu-RLC sublayer, a Uu-MAC sublayer, and a Uu-PHY sublayer of the gNB 180.

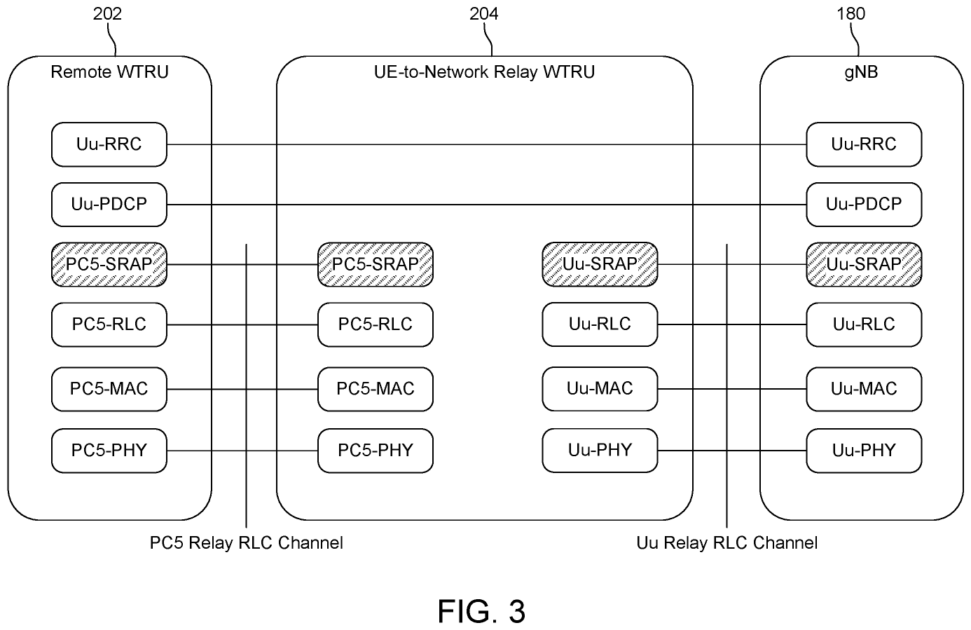

FIG. 3 is a L2 U2N Relay architecture diagram illustrating an example of control plane protocol stacks. The remote WTRU 202 may have a protocol stack which includes a Uu-RRC sublayer and a Uu-PDCP sublayer which correspond with a Uu-RRC sublayer and a Uu-PDCP sublayer of the gNB 180. The protocol stack at the remote WTRU 202 may also include a PC5-SRAP sublayer, a PC5-RLC sublayer, a PC5-MAC sublayer, and a PC5-PHY sublayer which correspond with a PC5-SRAP sublayer, a PC5-RLC sublayer, a PC5-MAC sublayer, and a PC5-PHY sublayer of the U2N relay WTRU 204. The protocol stack at the U2N relay WTRU 204 may also include a Uu-SRAP sublayer, a Uu-RLC sublayer, a Uu-MAC sublayer, and a Uu-PHY sublayer which correspond with a Uu-SRAP sublayer, a Uu-RLC sublayer, a Uu-MAC sublayer, and a Uu-PHY sublayer of the gNB 180.

As shown in FIGS. 2 and 3, the Sidelink Relay Adaptation Protocol (SRAP) sublayer is placed above the RLC sublayer for both the CP (Control Plane) and UP (User Plane) at both the PC5 interface and the Uu interface. The Uu SDAP, PDCP and RRC sublayers are terminated between the L2 U2N Remote WTRU 202 and the gNB 180, while the SRAP, RLC, MAC and PHY sublayers are terminated in each hop (i.e., the link between L2 U2N Remote WTRU 202 and L2 U2N Relay WTRU 204 and the link between L2 U2N Relay WTRU 204 and the gNB 180).

For the L2 U2N (UE-to-Network) Relay 204, the SRAP sublayer over the PC5 hop is only for the purpose of bearer mapping. The SRAP sublayer is not present over the PC5 hop for relaying the L2 U2N Remote WTRU's message on BCCH (Broadcast Control Channel) and PCCH (Paging Control Channel). For the L2 U2N Remote WTRU's message on SRB0 (Signaling Radio Bearer 0), the SRAP sublayer is not present over the PC5 hop, but the SRAP sublayer is present over the Uu hop for both DL and UL.

For uplink communications at the L2 U2N Relay 204:
The Uu SRAP sublayer supports UL bearer mapping between ingress PC5 Relay RLC channels for relaying and egress Uu Relay RLC channels over the L2 U2N Relay WTRU's Uu interface. For uplink relaying traffic, the different end-to-end RBs (SRBs or DRBs) of the same Remote WTRU and/or different Remote WTRUs 202 can be multiplexed over the same Uu Relay RLC channel.
The Uu SRAP sublayer supports L2 U2N Remote WTRU identification for the UL traffic. The identity information of L2 U2N Remote WTRU Uu Radio Bearer and a local Remote UE ID are included in the Uu SRAP header at UL in order for the gNB 180 to correlate the received packets for the specific PDCP entity associated with the right Uu Radio Bearer of a Remote WTRU 202.
The PC5 SRAP sublayer at the L2 U2N Remote WTRU 204 supports UL bearer mapping between Remote WTRU Uu Radio Bearers and egress PC5 Relay RLC channels.

For downlink communications at the L2 U2N Relay 204:
The Uu SRAP sublayer supports DL bearer mapping at the gNB 180 to map end-to-end Radio Bearers (SRBs, DRBs) of the Remote WTRU 202 into Uu Relay RLC channel over the Relay WTRU Uu interface. The Uu SRAP sublayer supports DL bearer mapping and data multiplexing between multiple end-to-end Radio Bearers (SRBs or DRBs) of a L2 U2N Remote WTRU and/or different L2 U2N Remote WTRUs 202 and one Uu Relay RLC channel over the Relay WTRU's Uu interface.
The Uu SRAP sublayer supports Remote WTRU identification for DL traffic. The identity information of the Remote WTRU Uu Radio Bearer and a local Remote WTRU ID are included in the Uu SRAP header by the gNB 180 at DL in order for the Relay WTRU 204 to map the received packets from the Remote WTRU Uu Radio Bearer to its associated PC5 Relay RLC channel.
The PC5 SRAP sublayer at the Relay WTRU 204 supports DL bearer mapping between ingress Uu Relay RLC channels and egress PC5 Relay RLC channels.
The PC5 SRAP sublayer at the Remote WTRU 202 correlates the received packets for the specific PDCP entity associated with the right Uu Radio Bearer of a Remote WTRU 202 based on the identity information included in the Uu SRAP header.

A local Remote UE ID is included in both the PC5 SRAP header and the Uu SRAP header. The L2 U2N Relay WTRU 204 is configured by the gNB 180 with the local Remote UE ID to be used in the SRAP header. The remote WTRU 202 obtains the local Remote ID from the gNB 180 via Uu RRC messages, including RRCSetup, RRCReconfiguration, RRCResume, and RRCReestablishment. Uu DRB(s) and Uu SRB(s) are mapped to different PC5 Relay RLC channels and Uu Relay RLC channels in both the PC5 hop and the Uu hop.

It is the gNB's responsibility to avoid collisions with respect to the usage of local Remote UE IDs. The gNB 180 can update the local Remote UE ID by sending the updated local Remote UE ID via RRCReconfiguration message to the Relay WTRU 204. The serving gNB 180 can perform local Remote UE ID update independent of the PC5 unicast link L2 ID update procedure.

### Multipath Operation with SL Relay in NR Release 18

3GPP has started the enhancements of the NR SL relay specification in Release 18. One of the features that will be discussed is the support of multi-path operation with a relay, where a remote WTRU is connected to the network via direct and indirect paths, which has the potential to improve the reliability and/or robustness as well as throughput for the remote WTRU.

The multi-path relay solution can also be utilized for WTRU aggregation where a WTRU is connected to the network via a direct path and via another WTRU using a non-standardized WTRU-WTRU interconnection. WTRU aggregation aims to provide applications requiring high UL bitrates on 5G terminals in cases where normal WTRUs may be too limited by UL WTRU transmission power to achieve a required bitrate, especially at the edge of a cell. Additionally, WTRU aggregation can improve the reliability, stability and delay of services as well. That is, if the channel condition of a terminal is deteriorating, another terminal can be used to make up for the traffic performance unsteadiness caused by the channel condition variation.

Multipath operation is listed as one of the core objectives of Release 18. Particularly, RP-213585 proposes to study the benefit and potential solutions for multi-path support to enhance reliability and throughput (e.g., by switching among or utilizing the multiple paths simultaneously) in the following scenarios where a UE is connected to the same gNB using one direct path and one indirect path via 1) Layer-2 UE-to-Network relay, or 2) via another UE (where the UE-UE inter-connection is assumed to be ideal). The solutions for 1) are to be reused for 2) without precluding the possibility of excluding a part of the solutions which is unnecessary for the operation for 2).

The study on the benefit and potential solutions are to be completed in RAN #98 which will decide whether and/or how to start the normative work.

The UE-to-Network relay in scenario 1) reuses the Release 17 solution as the baseline.

Support of Layer-3 UE-to-Network relay in multi-path scenario is assumed to have no RAN impact and the work and solutions are subject to SA2 to progress.

### Sidelink Measurements and Scheduling

In SL operation, the WTRU may configure the associated peer WTRU to perform NR sidelink measurement and report on the corresponding PC5-RRC connection in accordance with the NR sidelink measurement configuration for unicast by RRCReconfigurationSidelink message.

A WTRU shall derive NR sidelink measurement results by measuring one or more Demodulation Reference Signals (DMRSs) associated per PC5-RRC connection as configured by the associated peer WTRU. For all NR sidelink measurement results, the WTRU applies the layer 3 filtering before using the measured results for evaluation of reporting criteria and measurement reporting. In Release 16, only NR sidelink RSRP can be configured as the trigger quantity and reporting quantity.

The following measurement events are defined for NR sidelink:
Event S1: Serving cell becomes better than threshold;
Event S2: Serving cell becomes worse than threshold.

The S1 and S2 based measurement reports are used by the WTRU receiving the report to adjust the power level when transmitting data.

NR sidelink transmissions have the following two modes of resource allocations:
Mode 1: Sidelink resources are scheduled by a gNB;
Mode 2: The WTRU autonomously selects sidelink resources from a (pre-)configured sidelink resource pool(s) based on the channel sensing mechanism.

For an in-coverage WTRU, WTRUs can be configured to operate in Mode 1 or Mode 2. For an out-of-coverage WTRU, only Mode 2 can be adopted.

To enhance QoS of NR sidelink transmissions, congestion control is important (especially in Mode 2) to prevent a transmitting WTRU from occupying too many resources in sidelink transmissions. Two metrics are defined for this purpose:
Channel Busy Ratio (CBR): the portion of subchannels whose RSSI exceeds a preconfigured value over a certain time duration;
Channel Occupation Ratio (CR): fraction of the total number of sub-channels used by transmissions out of the total number of configured (granted) sub-channels over a given measurement.

For congestion control, an upper bound of CR denoted by CRlimit is imposed on a transmitting WTRU, where CRlimit is a function of CBR and the priority of the sidelink transmissions. The amount of resources occupied by a transmitting WTRU may not exceed CRlimit.

The CBR report is also used by the gNB to determine the pool of resources allocated to sidelink communication (e.g., increase the pool of resources if the WTRUs involved in sidelink communication are reporting high CBRs, decrease the pool of resources if the CBRs reported are low).

In addition to peer WTRUs involved in sidelink operation configuring each other for measurement (either periodical or S1/S2 events), for in coverage operation (i.e., the remote WTRU is within the coverage of the gNB), the gNB can configure the remote WTRU with CBR measurements, which can also be either periodic or event triggered. The following two measurement events can be configured for CBR measurement reporting:
Event C1: CBR of NR sidelink communication becomes better than an absolute threshold;
Event C2: CBR of NR sidelink communication becomes worse than the absolute threshold.

### Split Bearers in Dual Connectivity

In Dual Connectivity (DC), a WTRU is being served by two nodes, each comprising a set of cells comprising a Master Cell Group (MCG) and a Secondary Cell Group (SCG). A bearer can be associated with only the MCG, only the SCG, or it can be configured to be a split bearer.

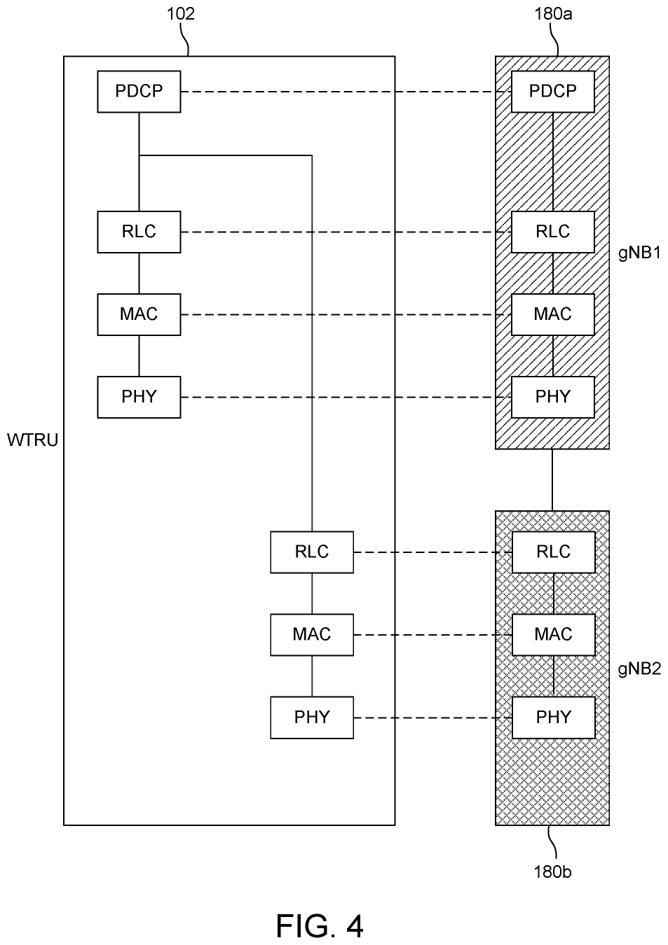

FIG. 4 is an architecture diagram illustrating an example protocol view of a split bearer.

Like any bearer, the WTRU 102 will have one PDCP entity associated with it, and the peer PDCP entity on the network side is terminated either at one of the gNBs 180a, 180b (either the master or the secondary). In the DL, the CN sends the data to the gNB where the PDCP is terminated (gNB1 in the figure above), and it is up to the network to directly send the data to the WTRU 102 via the link between that gNB1 180a and the WTRU 102, or forward the PDCP PDUs to gNB2 180b (e.g. via Xn interface), and gNB2 180b will send the data to the WTRU 102 via the link between itself and the WTRU 102.

In the UL, the WTRU 102 is configured with one of the paths as the primary path and the other as a secondary path. A threshold (e.g., a UL split buffer threshold) is also configured. If the UL buffer size for that bearer is less than the threshold, the PDCP will push the data only to the RLC associated with the primary path. However, if the buffer size becomes larger than the threshold, then the WTRU can push the data to either path (e.g., left up to WTRU implementation).

As discussed above, when the UL buffer size for a split bearer becomes greater than the UL split buffer threshold, the WTRU can push the data to either the primary path or the secondary path. One of the reasons for leaving this to WTRU implementation is that the scheduling of the two links is done independently by the two gNBs.

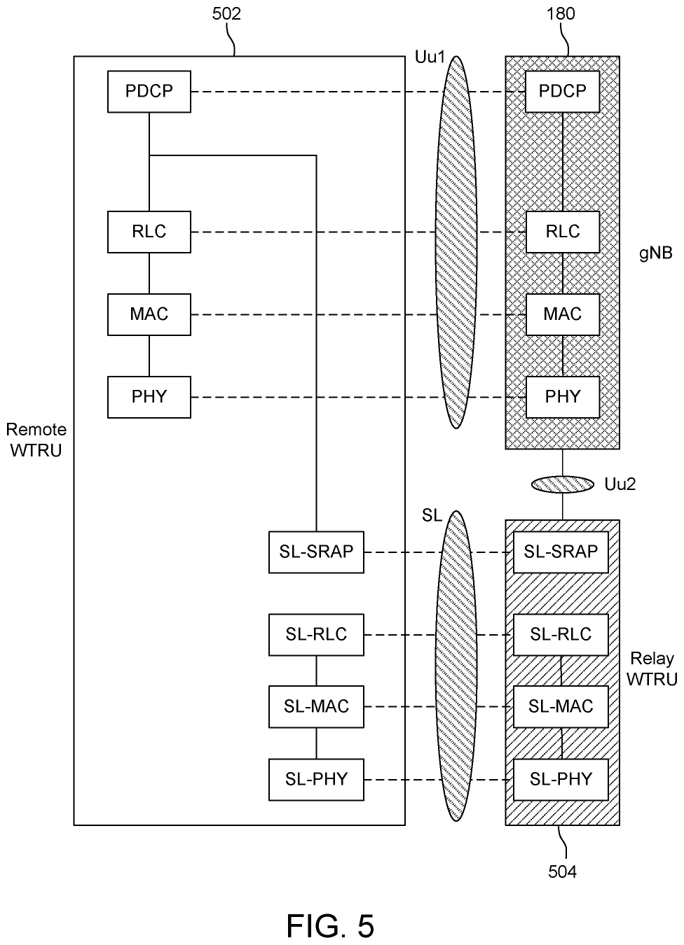

FIG. 5 is an architecture diagram illustrating an example protocol view of a split bearer in a case of multipath operation.

In multipath operation, the direct link between a remote WTRU 502 and the gNB 180 (e.g., Uu1) and the backhaul link between a relay WTRU 504 and the gNB 180 may be served by the same gNB 180, or even by the same cell of the same gNB 180. And if Mode 1 was chosen for the scheduling of the SL between the remote WTRU 502 and the relay WTRU 504, the scheduling of all the links (e.g., Uu1, Uu2, SL) are done by the gNB 180. Even if Mode 2 is used and a resource pool was pre-configured by the gNB 180 for the SL which the remote WTRU 502 can use autonomously, the gNB 180 is still the entity deciding the resource pool configuration, and thus has control of the scheduling over the SL (even though there is no specific grant or indication from the gNB 180 for each individual transmission, as in the case of Mode 1).

Thus, the legacy behavior of letting the WTRU decide the path selection for UL traffic of split bearers once the UL split buffer threshold has been exceeded is suboptimal in the multipath relay case, where the same gNB 180 is responsible for the scheduling of both links.

There have been proposals to consider the Uu and/or SL radio conditions (e.g., SL and/or Uu RSRP, SL CBR, etc.) in deciding whether to push data for a split bearer over the Uu and SL, instead of (or in addition to) the split buffer threshold (e.g., split buffer threshold dynamically updated based on the Uu and/or SL radio conditions).

Though such an approach would fare better than the fixed split buffer threshold approach, it does not consider conditions at the relay WTRU 504. For example, even if the radio conditions of the SL are excellent (e.g., high RSRP, low CBR, etc.), packets transmitted via the relay path (e.g., for split bearers, for SL terminated bearers, etc.) may experience significant delay and/or queuing at the relay WTRU 504 due to poor backhaul Uu radio conditions, extra buffering at the relay WTRU 504 due to pending UL data (e.g., relay WTRU 504 may be relaying several remote WTRUs 502), buffered DL data at the relay WTRU 504 (e.g., for the concerned remote WTRU 502 or for other remote WTRUs 502 for which the WTRU 504 is acting as a relay) that will likely cause CBR increase in the SL path and will likely degrade performance.

### Overview

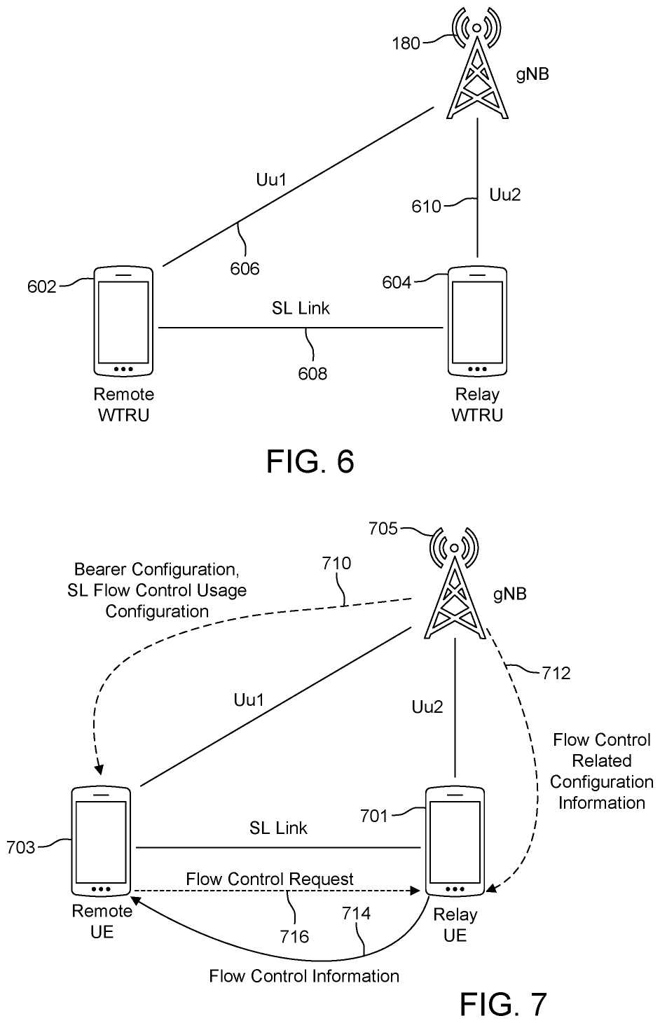

FIG. 6 is a system diagram illustrating an example multipath scenario. Certain representative embodiments in this disclosure are mainly targeted toward the multipath scenario described hereinbelow and shown in FIG. 6. In FIG. 6, a remote WTRU 602 (e.g., a WTRU 102) is connected via a direct link and a relayed link, via a SL relay WTRU 604 (e.g., another WTRU 102), to the same gNB 180. However, without loss of generality, certain representative embodiments described hereinbelow are applicable to other scenarios, such as (1) a WTRU in Dual Connectivity to two different gNBs, where one of the links is a direct link and the other is a relayed link, (2) a remote WTRU 602 is connected via two or more relays, or (3) multihop scenarios (e.g., where the relay WTRU 604 is further connected to a parent relay WTRU, which is connected to the gNB). In FIG. 6, the direct link 606 corresponds to the Uu1 interface between the remote WTRU 602 and the gNB 180. The relayed link corresponds to the SL link 608 between the remote WTRU 602 and the relay WTRU 604 and the Uu2 link 610 between the relay WTRU 604 and the gNB 180.

In all the representative embodiments described below, it is assumed that split bearers can be configured, as in legacy NR, with a primary path (either the Uu1 link 606 or SL link 608) and a secondary path (either the SL link 608 or Uu1 link 606). An UL split buffer threshold can be configured, where setting the threshold to zero means there is no primary path and setting it to infinity means only the primary path is used no matter the UL buffer size.

### Flow Control Information from Relay WTRU to Remote WTRU

In certain representative embodiments, a relay WTRU 604 may be configured by a gNB 180 to provide flow control (FC) information to a remote WTRU 602. For example, FC information may include any of DL buffer status, UL buffer status, DL buffer level, DL buffer status change rate, UL buffer status change rate, latency over the backhaul Uu, radio link information about the backhaul Uu, and/or availability of UL resources on the Uu.

In certain representative embodiments, DL buffer status may concern data pending to be transmitted from the relay WTRU 604 to any remote WTRUs 602. For example, DL buffer status may refer to the total DL buffer level at the relay WTRU 604 for a concerned remote WTRU 602. For example, DL buffer status may refer to the total DL buffer level at the relay WTRU 604 for any (e.g., all) remote WTRUs 602 being served by the relay WTRU 604. For example, DL buffer status may refer to the DL buffer level at the relay WTRU 604 for a concerned remote WTRU 602 for any of certain bearers, logical channels (e.g., LCIDs), radio link control (RLC) channels, etc. For example, DL buffer status may refer to the DL buffer level at the relay WTRU 604 for all remote WTRUs 602 for any of certain bearers, LCIDs, RLC channels, etc.

In certain representative embodiments, UL buffer status may concern data pending to be transmitted from the relay WTRU 604 to the gNB 180. For example, the UL buffer status may refer to the total UL buffer level at the relay WTRU 604 for a concerned remote WTRU 602. For example, the UL buffer status may refer to the total UL buffer level at the relay WTRU 604 for any (e.g., all) remote WTRUs 602 being served by the relay WTRU 604. For example, the UL buffer status may refer to the DL buffer level at the relay WTRU 604 for a concerned remote WTRU 602 for certain bearers, LCIDs, RLC channels, etc.

In certain representative embodiments, the DL buffer level at the relay WTRU 604 may concern any (e.g., all) remote WTRUs 602 for certain bearers, LCIDs, RLC channels, etc.

In certain representative embodiments, the DL buffer status change rate may be provided similar to the DL buffer status, but considering the rate of change, such as within a given configured time.

In certain representative embodiments, the UL buffer status change rate may be provided similar to the UL buffer status, but considering the rate of change, such as within a given configured time.

In certain representative embodiments, the latency over the backhaul Uu may relate to the amount of time packets take to traverse the backhaul Uu link. For example, the latency may be configured to include the buffering time at the relay WTRU 604, such as from the reception of a packet at the relay WTRU 604 from the Uu to the time the ACK (e.g., HARQ ACK for all transport blocks that contain data of this packet) is received from the gNB 180. For example, the latency may be (e.g., only) the transmission time over the Uu, such as where buffering time at the relay WTRU 604 is not considered. For example, the latency may be any of the average/mean, max, minimum, standard deviation, and/or moving average filtered value with some coefficients favoring older or recent latency values, etc. For example, the latency may be calculated per LCID, per bearer, per remote WTRU 602, etc.

In certain representative embodiments, the radio link information about the backhaul Uu may refer to any of RSRP, RSRQ, SINR, etc. of the backhaul Uu. For example, the radio link information may be any of the average/mean, max, minimum, standard deviation, moving average filtered value with some coefficients favoring older or recent radio link signal levels, etc.

In certain representative embodiments, the availability of UL resources on Uu may refer to the presence of an UL configured grant for the relay WTRU 604 on the Uu. For example, the availability of UL resources may include details such as size, duration, and/or periodicity.

In certain representative embodiments, FC information may (e.g., additionally) include information such as the DL data rate between the gNB 180 and the relay WTRU 604, the DL data rate between the relay WTRU 604 and remote WTRUs 602 other than the concerned WTRU, UL data rate between the gNB 180 and the relay WTRU 604, etc. For example, each such piece of information may have an associated granularity, such as at the bearer and/or LCID level.

In certain representative embodiments, FC information may (e.g., additionally) include any of an RRC state change by the relay WTRU 604, failure related information (e.g., handover failure or radio link failure experienced at the relay WTRU 604), and mobility of the relay WTRU 604 (e.g., relay WTRU 604 being handed over from one cell of the same gNB 180 to another, relay WTRU 604 being handed over to another gNB 180, etc.).

### Triggering of Flow Control Report/Information from Relay WTRU to Remote WTRU

In certain representative embodiments, a relay WTRU 604 may be configured to provide the FC information and/or report to the remote WTRU 602 periodically (e.g., every X ms).

In certain representative embodiments, a relay WTRU 604 may be configured to provide the FC information/report to the remote WTRU 602 based on triggering conditions, which, for example, may include any of the following:
DL buffer level is above/below/within certain threshold(s);
UL buffer level is above/below/within certain threshold(s);
DL buffer change rate is above/below/within certain threshold(s);
UL buffer change rate is above/below/within certain threshold(s); and/or
Latency over backhaul Uu is above/below/within certain threshold(s).

For example, any of the thresholds above could be specified at different granularity levels (e.g., concerning all remote WTRUs, in relation to the remote WTRU 602 where the FC is being provided, concerning only particular bearers/LCID/RLC channels, etc.).

For example, the relay WTRU 604 may be configured to provide the FC information/report to the remote WTRU 602 when its RRC state changes.

For example, the relay WTRU 604 may be configured to provide the FC information/report to the remote WTRU 602 when it performs a Handover (HO) or cell re-selection.

For example, the relay WTRU 604 may be configured to provide the FC information/report to the remote WTRU 602 when it encounters failures (e.g., HO failure, RLF, etc.,)

For example, the relay WTRU 604 may be configured to provide the FC information/report to the remote WTRU 602 based on a request by the remote WTRU 602. This may be performed in a one-time request-response fashion. Alternately, the remote WTRU 602 may subscribe to receive the information (e.g., periodically, or specify triggering conditions similar to the ones discussed above in relation to gNB specified triggering conditions). The remote WTRU 602 may also indicate which information it is interested in (e.g., UL buffer level or/and DL buffer level and/or latency, etc.).

For example, the relay WTRU 604 may be configured to provide the FC information/report to the remote WTRU 602 via dedicated signaling (e.g., PC5-RRC, MAC CE, etc.).

For example, the relay WTRU 604 may be configured to provide the FC information/report to the remote WTRU 602 via broadcast/groupcast signaling over the PC5.

### Remote WTRU Action Based on Flow Control Information Received from Relay WTRU

In certain representative embodiments, a remote WTRU 602 may be configured to modify the UL split buffer threshold used by a split bearer based on the received FC from the relay WTRU 604 (e.g., considering one or more the values of the indicated flow control elements).

For example, a WTRU may be configured with multiple split buffer threshold values. Each value may correspond to a specific value or range of values of one or more of the elements in the FC information/report (e.g., threshold1 when the UL buffer level indicated in the FC is below level1, threshold2 for when the UL buffer level indicated in the FC is below level2, etc.)

For example, a WTRU may be configured with a baseline split buffer threshold value and a scaling factor that depends on a specific value or range of values of one or more of the elements in the FC information/report. For example, the WTRU may be configured to use a baseline split buffer threshold when the UL buffer level indicated in the FC is below level1, and, for values above level1, increase/decrease the split buffer threshold by a percentage difference between the indicated value and level1. For example, the percentage difference may be determined based on the scaling factor. For example, the increase (or decrease) may be based on a function of any of the scaling factor, the baseline split buffer threshold, the percentage difference, and/or level1.

For example, a WTRU may be configured with a baseline buffer threshold value and applies a delta value that depends on the specific value or range of values of one or more of the elements in the FC information/report (e.g., use a baseline split buffer threshold when the UL buffer level indicated in the FC is below level1, and, for values above level1, apply an increase/decrease of a certain amount/percentage for every buffer level increase of a certain amount/percentage, etc.).

In certain representative embodiments, a remote WTRU 602 may be configured to distribute the UL data between the Uu and the SL based on a dynamic distribution percentage (e.g., 20% on the Uu, 80% on the SL), where the percentage is dependent on the values of one or more of the elements included in the received FC.

For example, a WTRU may be configured with multiple distribution percentage values, each corresponding to a specific value or range of values of one or more of the elements in the FC information/report (e.g., percentage1 of UL data to put on SL if UL buffer level indicated in the FC information is below level 1, percentage2 of UL data to put on SL if UL buffer level indicated in the FC information is between level 1 and level 2, and percentage 3 of UL data to put on SL if the UL buffer level indicated in the FC information is above level 3).

For example, a WTRU may be configured with a baseline distribution percentage value and a scaling factor that depends on a specific value or range of values of one or more of the elements in the FC information/report. For example, the WTRU may be configured to use the baseline distribution percentage if the UL buffer level indicated in the FC is below level1, and decrease the threshold by the percentage difference between the current indicated UL buffer level and level1 otherwise. For example, the percentage difference may be determined based on the scaling factor. For example, the decrease may be based on a function of any of the scaling factor, the baseline split buffer threshold, the percentage difference, and/or level1.

In some embodiments, the WTRU may be configured to switch the primary path of a certain split bearer depending on the received FC.

For example, a WTRU may be configured to switch the primary path to the SL if the FC indicates the UL buffer level at the relay WTRU 604 is below level1.

For example, a WTRU may be configured to switch the primary path to the Uu if the FC indicates the UL buffer level at the relay WTRU 604 is above level2.

For example, a WTRU may select the primary path for the case of two paths via the relay based on the path having the lowest UL buffer level.

In certain representative embodiments, the WTRU may be configured to pause or stop the usage of the SL for UL data transmission depending on the received FC information. For example, the WTRU may be configured to pause/stop the usage of the SL if the FC indicates the UL buffer level at the relay WTRU 604 is above level1. This behavior could be for any bearer (e.g., split bearer, SL bearer, etc.) or it could be configured separately for the split bearers and SL bearers (e.g., set a lower UL buffer level threshold for stopping the transmission of UL data via the SL for split bearers, and set a higher UL buffer level threshold for stopping the transmission of UL data via the SL for SL bearer, etc.)

In certain representative embodiments, the WTRU may be configured to resume the usage of the SL for UL data transmission depending on the received FC. For example, the WTRU may be configured to resume the usage of the SL if the FC indicates the UL buffer level at the relay WTRU 604 is below level2. This behavior could be for any bearer (e.g., split bearer, SL bearer, etc.) or it could be configured separately for the split bearers and SL bearers (e.g., set a lower UL buffer level threshold for resuming the transmission of UL data via the SL for SL bearers, and set a higher UL buffer level threshold for resuming the transmission of UL data via the SL for split bearers, etc.).

In certain representative embodiments, the remote WTRU 602 may perform any of the actions above based on a single FC report.

In certain representative embodiments, the remote WTRU 602 may perform any of the actions above based on a certain number of consecutive FC reports (e.g., a certain number of consecutive FC reports received, such as within a certain time, indicating that the UL buffer level is larger than the configured level for changing the path selection behavior).

In certain representative embodiments, the remote WTRU 602 may perform any of the actions above based on the difference or rate of change of reported values of one or more of the elements of two or more consecutive FC reports (e.g., the UL buffer level indicated in the current FC report has increased by x % over the amount reported in the previous FC report).

### Consideration of the Serving Cells of the Uu and SL

Application of the above embodiments may further depend on whether the SL and Uu paths are associated with the same cell or different cells.

In certain representative embodiments, the remote WTRU 602 may apply any of the embodiments discussed above only if the SL is also being served by the same cell as the Uu link, or vice versa. Alternatively, the remote WTRU 602 may apply a different embodiment or different behavior when the SL and Uu are served by different cells. Alternately, the remote WTRU 602 may not consider the flow control for the case of different cells.

In certain representative embodiments, the remote WTRU 602 may be configured to apply different configurations depending on whether the SL is being served by a cell different from the cell serving the Uu link. For example, the WTRU may be configured with two sets of configurations, one applicable for the case of the same cell and another for the case of the different cells. Alternately, instead of two sets of configurations, the WTRU may be configured with a configuration related to the same cell scenario, and information on how to convert the split buffer thresholds or distribution factors to the different cell scenario (e.g., a delta value or a scaling factor to apply)

In certain representative embodiments, the remote WTRU 602 may be configured to apply different configurations depending on whether the SL is being served by a gNB different from the gNB 180 serving the Uu link (e.g., WTRU is in DC operation, WTRU able to identify the gNB ID from the cell identity). For example, the WTRU may be configured with two sets of configurations, one applicable for the case of the same gNBs and another for the case of the different gNBs. Alternately, instead of two sets of configurations, the WTRU may be configured with a configuration related to the same gNB scenario, and information on how to convert the buffer thresholds or distribution factors to the different gNB scenario (e.g., a delta value or a scaling factor to apply).

### Consideration of Resource Allocation Mode at Remote WTRU

Application of the above embodiments may further depend on the resource allocation mode of the remote WTRU 602 on SL.

In certain representative embodiments, the remote WTRU 602 may apply any of the embodiments discussed above only if the remote WTRU 602 is configured with a Mode 2 resource allocation. Otherwise, it applies a different embodiment or does not consider flow control when the remote WTRU 602 is configured with a Mode 1 resource allocation.

### Applicability to a Particular Bearer or Set of Bearers

In certain representative embodiments, a split bearer configuration according to any of the embodiments above may be applicable to all bearers. For example, each split bearer has its own split buffer configuration which may contain a set of split buffer thresholds that correspond to specific ranges of UL buffer levels reported by the FC information/report, or a baseline threshold and scaling factor or delta values and how to apply the scaling/delta when the UL buffer level is above/below this baseline threshold.

In certain representative embodiments, the split bearer configuration according to any of the solutions above may be configured per each split bearer.

In certain representative embodiments, the split bearer configuration according to any of the embodiments above may be applicable to all split bearers with the Uu as the primary path.

In certain representative embodiments, the split bearer configuration according to any of the solutions above may be applicable to all split bearers with the SL as the primary path.

In certain representative embodiments, the split bearer configuration according to any of the solutions above may be applicable to a set of split bearers (e.g., bearers that belong within a list of bearers, such as, bearer IDs, bearers with a certain QoS type, Logical channels with a priority above a threshold, etc.).

In certain representative embodiments, the split bearer may share a part of the split bearer configuration and have other parts that are bearer specific (e.g., for each bearer, for a subset of bearers). For example, each split bearer may have its own baseline split buffer threshold, and all the bearers or a subset of the bearers (e.g., specified in a list of bearer IDs or a QoS types), share a scaling factor or a delta value to apply when the UL buffer level reported in the FC information is above a certain value.

### Indication to Network About Modified Behavior

In certain representative embodiments, a remote WTRU 602 may be configured to send an indication to the network whenever the behavior regarding the split bearer operation is updated. For example, the WTRU may send an indication to the network when the WTRU performs one or more of the following actions due to received FC report/information:
updating the split bearer buffer threshold;
updating the distribution percentage between the Uu and SL;
switching the primary path of a split bearer to the Uu
switching the primary path of a split bearer to the SL;
pausing any data transmission over the SL; and/or
resuming data transmission over the SL.

In certain representative embodiments, any change is indicated by the remote WTRU 602.

In certain representative embodiments, the change must be significant, according to some pre-configuration, to trigger an indication to the network. For example, the remote WTRU 602 may be configured to send an indication to the network when the split buffer threshold has changed by a certain amount (e.g., absolute value, percentage value, etc.).

In certain representative embodiments, the indication to the network may be sent via a dedicated message (e.g., RRC, MAC CE, etc.).

In certain representative embodiments, the indication may be included in another message (e.g., in a measurement report, in SL or Uu buffer status report (BSR) sent to the gNB, etc.).

In certain representative embodiments, the WTRU may keep a log of the change history of its behavior (e.g., split bearer changes).

In certain representative embodiments, the network may request the information (e.g., in a WTRU assistance information message).

In certain representative embodiments, the indication sent to the network may contain information regarding the flow control information received from the relay WTRU 604 (e.g., detailed information, summary information over a certain configured period, information about outlier flow control information, such as that the indicated values are greater than or smaller than some configured value, etc.).

FIG. 7 is a system diagram illustrating an example of signaling to enable certain representative embodiments discussed above. In FIG. 7, a relay WTRU 701, a remote WTRU 703, and a gNB 705 are in communication. As in legacy systems, the remote WTRU 703 is provided bearer configuration information and/or SL flow control usage configuration information. The bearer configuration information and/or SL flow control usage configuration information may be received over either the SL or Uu1 link, but, in FIG. 7 is shown at 710 as being received via the Uu1 link from the gNB 705. In addition, the relay WTRU 701 may receive flow control related configuration information 712 via the Uu2 link from the gNB 705, such as what triggers to use to send flow control information 714 to a remote WTRU and what particular flow control information 714 to send.

As shown, the relay WTRU 701 may transmit flow control information 714 to the relay WTRU 703. The flow control information 714 may include any of DL transmission status (e.g., level/status to the remote UE, to let the remote UE know how much data is pending in the DL over SL), UL transmission status (e.g., buffer level/status to let the remote UE know how much data is pending in the UL over the backhaul Uu2), latency over Uu, radio link quality of the backhaul Uu2, RRC state change of the relay UE 701, failure indication (RLF, HOF), etc. The relay WTRU 701 may send the flow control information to the remote UE 703 periodically and/or based on one or more of buffer level thresholds, latency thresholds, Uu quality thresholds, a request from the remote UE (e.g., such as illustrated by a flow control request 716 in FIG. 7), an RRC state change, and/or detection of failures (e.g., RLF, HOF, etc.). As noted above in connection with the flow control related configuration information 712 in FIG. 7, both the triggers for transmitting flow control information 714 and the type of flow control information 714 transmitted may be configured in the relay WTRU 701 by the gNB 705.

The remote WTRU 703 is configured to change its behavior based on the flow control information 714 from the relay WTRU 701. These changes may include one or more of how much data is transmitted over the SL for split bearers, suspend/resume the SL path for some bearers (e.g., suspend for a given time when a bad FC is received, suspend until a good FC is received that indicates better conditions at the relay WTRU 701, etc.), different behaviors for different bearers (depending on QoS profile of the bearers), and sending an indication to the gNB 705 about changed behavior (e.g., SL path suspension, split bearer threshold modification, etc.).

Although not depicted in FIG. 7, as mentioned previously, the remote WTRU 703 may report (e.g., indicate) to the network, via the Uu1 or SL link, information about the flow control changes that have been made at the remote WTRU 703.

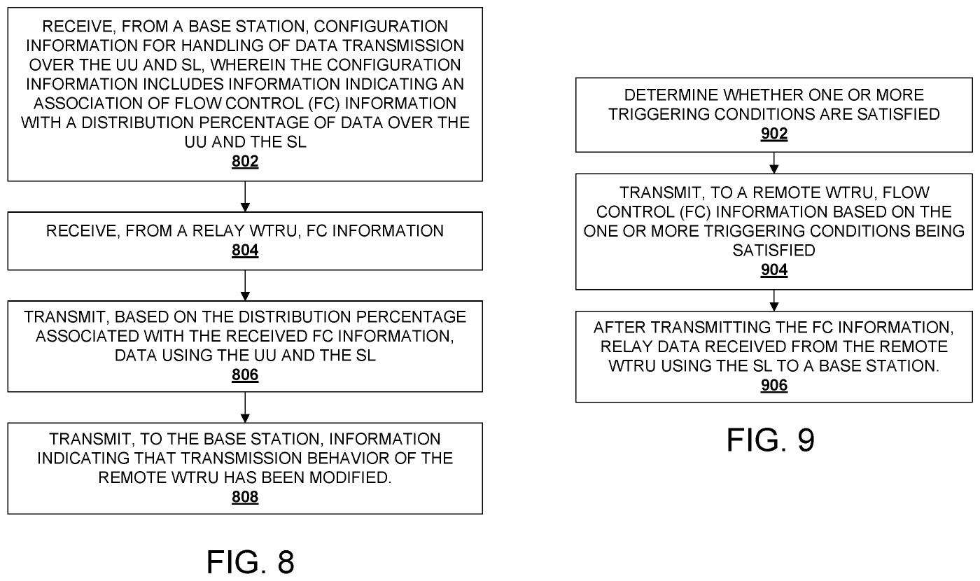

FIG. 8 is a procedural diagram illustrating an example procedure for flow control at a remote WTRU 602. In certain representative embodiments, the remote WTRU 602 may operate in a multipath setting using a direct link (e.g., Uu) with a base station (e.g., gNB 180) and a sidelink (SL) with a relay WTRU 604. For example, the relay WTRU 604 may use a backhaul direct link (Uu) with a same or different base station (e.g., gNB 180) than the remote WTRU 602. For example, the remote WTRU 602 and/or the relay WTRU 604 may be provided as respective WTRUs 102.

As shown in FIG. 8, the remote WTRU 602 may receive, from a base station (e.g., gNB 180), configuration information for handling of data transmission over the Uu and SL at 802. For example, the configuration information may include information indicating an association of FC information with a distribution percentage of data over the Uu and the SL. For example, the configuration information received at 802 may be provided as the SL FC usage configuration at 710. At 804, the remote WTRU 602 may receive, from the relay WTRU 604, FC information. For example, the FC information received at 804 may be provided as the FC information at 714. At 806, the remote WTRU 602 may transmit, based on the distribution percentage associated with the received FC information, data using the Uu and the SL. At 808, the remote WTRU 602 may transmit, to the base station, information indicating that transmission behavior of the remote WTRU has been modified.

In certain representative embodiments, the configuration information (e.g., received at 802) may include information indicating an association of a set of FC information and a set of distribution percentages. For example, the set of FC information may include the FC information (e.g., which is to be received at 804). For example, the set of distribution percentages may include the distribution percentage.

In certain representative embodiments, the remote WTRU 602 may determine the distribution percentage from a set of distribution percentages based on the association with the received FC information.

In certain representative embodiments, the configuration information may further include information indicating a scaling factor and/or a threshold. For example, the remote WTRU 602 may transmit the data using the Uu and the SL at 808 based on (i) the received FC information being above the threshold, (ii) the distribution percentage associated with the received FC information, and/or (iii) the distribution percentage which is modified using the scaling factor.

In certain representative embodiments, the configuration information may also include information indicating a threshold. For example, the remote WTRU 602 may transmit the data using the Uu and the SL at 808 based on (i) the distribution percentage associated with the received FC information, and (ii) a difference between the received FC information and the threshold.

In certain representative embodiments, the received FC information may include any of a downlink buffer state of data to be transmitted by the relay WTRU, a rate of change of the downlink buffer state, a downlink data rate at the relay WTRU, an uplink buffer state of data to be transmitted by the relay WTRU, a rate of change of the uplink buffer state, an uplink data rate at the relay WTRU, a latency of a backhaul Uu between the relay WTRU and a base station, radio link information of the backhaul Uu, resource availability of the backhaul Uu, and/or a connection state of the backhaul Uu. For example, the downlink buffer state may be associated with data to be transmitted by the relay WTRU 604 using the SL to the remote WTRU 602. For example, the uplink buffer state may be associated with data to be transmitted by the relay WTRU 604 using the backhaul Uu.

In certain representative embodiments, the configuration information may be associated with a cell that serves the remote WTRU and the relay WTRU.

In certain representative embodiments, the configuration information may be associated with a first cell that serves the remote WTRU. For example, the first cell may be different than a second cell that serves the relay WTRU.

In certain representative embodiments, the Uu and the SL may be associated with a split bearer. For example, a split bearer may be configured to use the Uu and the SL as primary and secondary paths, or vice versa.

In certain representative embodiments, the Uu may be set as a primary path of the split bearer, such as based on the received FC information.

In certain representative embodiments, the SL may be set as a primary path of the split bearer, such as based on the received FC information.

In certain representative embodiments, the information indicating that the transmission behavior of the remote WTRU has been modified may be included in any of a radio resource control (RRC) message, a medium access control (MAC) control element, a measurement report, and/or a buffer status report (BSR).

FIG. 9 is a procedural diagram illustrating an example procedure for enabling flow control by a relay WTRU 604. In certain representative embodiments, the relay WTRU 604 may operate to provide a multipath setting for a remote WTRU 602 that uses a direct link (e.g., Uu) with a base station (e.g., gNB 180) and a sidelink (SL) with the relay WTRU 604. For example, the relay WTRU 604 may use a backhaul direct link (Uu) with a same or different base station (e.g., gNB 180) than the remote WTRU 602. For example, the remote WTRU 602 and/or the relay WTRU 604 may be provided as respective WTRUs 102.

As shown in FIG. 9, the relay WTRU 604 may determine whether one or more triggering conditions are satisfied at 902. At 904, the relay WTRU 604 may transmit, to the remote WTRU, FC information based on the one or more triggering conditions being satisfied. For example, the FC information transmitted at 904 may be provided as the FC information at 714. At 906, after transmitting the FC information at 904, the relay WTRU 604 may relay data received from the remote WTRU 602 using the SL to a base station. For example, the remote WTRU 602 may have modified its usage of the SL based on the FC information transmitted by the relay WTRU 604 at 904.

In certain representative embodiments, the FC information transmitted at 904 may be associated with a distribution percentage of data to be transmitted by the remote WTRU 602 using the Uu between the remote WTRU 602 and the base station and the SL between the remote WTRU 602 and the relay WTRU 604.

In certain representative embodiments, the relay WTRU 604 may receive, from the base station, configuration information indicating the one or more triggering conditions. For example, the configuration information indicating the one or more triggering conditions may be provided to the relay WTRU 604 as (e.g., part of) the FC related configuration information at 712.

In certain representative embodiments, the relay WTRU 604 may receive, from the base station, configuration information indicating one or more types of the FC information which are associated with the one or more triggering conditions. For example, various triggering conditions for providing the FC information to the remote WTRU 602 are described herein, such as triggers relating to the UL buffer and/or DL buffer of the relay WTRU 604.

In certain representative embodiments, the FC information transmitted at 904 may include any of a downlink buffer state of data to be transmitted by the relay WTRU, a rate of change of the downlink buffer state, a downlink data rate at the relay WTRU, an uplink buffer state of data to be transmitted by the relay WTRU, a rate of change of the uplink buffer state, an uplink data rate at the relay WTRU, a latency of a backhaul Uu between the relay WTRU and the base station, radio link information of the backhaul Uu, resource availability of the backhaul Uu, and/or a change in connection of the backhaul Uu.

In certain representative embodiments, the one or more triggering conditions may include any of a configured time period, a downlink buffer state of data to be transmitted by the relay WTRU 604 being above (or below a threshold), a rate of change of the downlink buffer state being above (or below a threshold), an uplink buffer state of data to be transmitted by the relay WTRU 604 being above (or below a threshold), a rate of change of the uplink buffer state being above (or below a threshold), a latency of a backhaul direct link (Uu) between the relay WTRU and the base station being above (or below a threshold), a change in connection of the backhaul Uu, and/or a request for FC information is received from the remote WTRU 602.

In certain representative embodiments, the one or more triggering conditions may be associated with (e.g., data to be transmitted using) one or more split bearers, one or more logical channels, one or more radio link control channels, the remote WTRU, and/or a group of remote WTRUs.

In certain representative embodiments, the FC information at 904 may be included in any of a radio resource control (RRC) message and/or a medium access control (MAC) control element.

In certain representative embodiments, the FC information at 904 may be transmitted via broadcast or groupcast signaling using the SL.

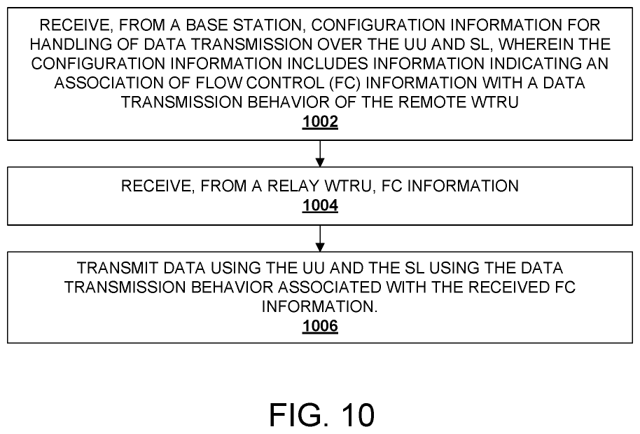

FIG. 10 is a procedural diagram illustrating another example procedure for flow control at a remote WTRU 602. In certain representative embodiments, the remote WTRU 602 may operate in a multipath setting using a direct link (e.g., Uu) with a base station (e.g., gNB 180) and a sidelink (SL) with a relay WTRU 604. For example, the relay WTRU 604 may use a backhaul direct link (Uu) with a same or different base station (e.g., gNB 180) than the remote WTRU 602. For example, the remote WTRU 602 and/or the relay WTRU 604 may be provided as respective WTRUs 102.

As shown in FIG. 10, the remote WTRU 602 may receive, from a base station, configuration information for handling of data transmission over the Uu and SL at 1002. For example, the configuration information may include information indicating an association of flow control (FC) information with a data transmission behavior of the remote WTRU 602. For example, the configuration information received at 1002 may be provided as the SL FC usage configuration at 710. At 1004, the remote WTRU 602 may receive, from the relay WTRU 604, FC information. For example, the FC information received at 804 may be provided as the FC information at 714. At 1006, the remote WTRU 602 may transmit data using the Uu and the SL using the data transmission behavior associated with the received FC information.

In certain representative embodiments, the configuration information received at 1002 may include information indicating an association of a set of FC information and a set of data transmission behaviors of the remote WTRU 602. For example, various data transmission behaviors (e.g., remote WTRU actions) are described herein.

In certain representative embodiments, the remote WTRU 602 may determine the data transmission behavior from the set of data transmission behaviors based on the association with the received FC information.

In certain representative embodiments, the data transmission behavior may include an uplink split buffer threshold (or modification thereof). For example, the remote WTRU 602 may transmit the data using (e.g., distributed over) the Uu and the SL at 1006 based on an amount of the data to be transmitted at 1006 and the uplink split buffer threshold.

In certain representative embodiments, the data transmission behavior may include a distribution percentage between the Uu and the SL. For example, the remote WTRU 602 may transmit the data using (e.g., distributed over) the Uu and the SL at 1006 based on the distribution percentage.

In certain representative embodiments, the data transmission behavior may include a setting of one of the Uu and the SL as a primary path. For example, the remote WTRU 602 may transmit the data using (e.g., distributed over) the Uu and the SL at 1006 based on the primary path and/or an uplink buffer level.

In certain representative embodiments, the data transmission behavior may include resuming (or pausing) the usage of one of the Uu and the SL. For example, the remote WTRU 602 may transmit the data at 1006 which includes resuming the usage of the Uu or the SL. For example, the remote WTRU 602 may transmit the data at 1006 which includes pausing the usage of the SL or the SL.

In certain representative embodiments, the received FC information may include any of a downlink buffer state of data to be transmitted by the relay WTRU 604, a rate of change of the downlink buffer state, a downlink data rate at the relay WTRU 604, an uplink buffer state of data to be transmitted by the relay WTRU 604, a rate of change of the uplink buffer state, an uplink data rate at the relay WTRU, a latency of a backhaul Uu between the relay WTRU 604 and a base station (e.g., gNB 180), radio link information of the backhaul Uu, resource availability of the backhaul Uu, and/or a connection state of the backhaul Uu.

In certain representative embodiments, the downlink buffer state may be associated with data to be transmitted by the relay WTRU 604 to the remote WTRU 602 using the SL.

In certain representative embodiments, the uplink buffer state may be associated with data to be transmitted by the remote WTRU 604 using the backhaul Uu.

In certain representative embodiments, the configuration information may be associated with a cell that serves the remote WTRU 602 and the relay WTRU 604.

In certain representative embodiments, the configuration information may be associated with a first cell that serves the remote WTRU 602. The first cell may be different than a second cell that serves the relay WTRU 604.

In certain representative embodiments, the Uu and the SL may be associated with a split bearer. For example, a split bearer may be configured to use the Uu and the SL as primary and secondary paths, or vice versa.

In certain representative embodiments, the Uu may be set as a primary path of the split bearer, such as based on the received FC information.

In certain representative embodiments, the SL may be set as a primary path of the split bearer, such as based on the received FC information.

In certain representative embodiments, the remote WTRU 602 may transmit, to the base station, information indicating that transmission behavior of the remote WTRU 602 has been modified. For example, the information indicating that the transmission behavior of the remote WTRU has been modified may be included in any of a RRC message, a MAC-CE, a measurement report, or a buffer status report (BSR).

In certain representative embodiments, a WTRU 102 may function as a relay WTRU 604 for a remote WTRU 602. The WTRU 102 may receive, from a network, a configuration for transmitting flow control information to the remote WTRU 602. The WTRU 102 may detect a trigger event for transmitting flow control information to the remote WTRU 602. The WTRU 102 may transmit the flow control information to the remote WTRU 602. The transmission of the flow control information to the remote WTRU 602 may be responsive to the detection of the trigger event.

In certain representative embodiments, the flow control information may include at least one of a downlink buffer status at the relay WTRU 604, an uplink buffer status at the relay WTRU 604, a latency over a backhaul Uu, a radio link quality of a backhaul Uu, an RRC state change of the relay WTRU 604, activity level at the relay WTRU 604, and/or a failure indication.

In certain representative embodiments, the trigger event for transmitting FC information to the remote WTRU 602 may include expiration of a predetermined (e.g., time) period since a last transmission of FC information to the remote WTRU 602, meeting a buffer level threshold, meeting a latency threshold, meeting a Uu quality threshold, receiving a request from the remote WTRU 602, an RRC state change, a radio link failure, and/or a handover failure.

In certain representative embodiments, a WTRU 102 may function as a remote WTRU 602 in communication with a relay WTRU 604 via SL communications. The remote WTRU 602 may receive FC information from the relay WTRU 604. The remote WTRU 602 may modify data transmission and/or data reception configurations at the remote WTRU 602 in response to the FC information.

In certain representative embodiments, the remote WTRU 602 may receive, from a network (e.g., gNB 180), a radio bearer configuration for SL communications and Uu communications.

In certain representative embodiments, the FC information may include at least one of a downlink buffer status at the relay WTRU 604, an uplink buffer status at the relay WTRU 604, a latency over a backhaul Uu, a radio link quality of backhaul Uu, a RRC state change of the relay WTRU 604, an activity level at the relay WTRU 604, and/or a failure indication at the relay WTRU 604.

In certain representative embodiments, the remote WTRU 602 may transmit an indication to a network of a modified behavior of the remote WTRU 602 which may be responsive to the remote WTRU 602 modifying its behavior regarding transmission of data over the SL (e.g., responsive to the received FC information).

In certain representative embodiments, the modified behavior may include at least one of the remote WTRU 602 updating a split bearer buffer threshold, the remote WTRU 602 updating a distribution percentage between a Uu link and the SL link for a split bearer, the remote WTRU 602 switching the primary path of a split bearer to the Uu link, the remote WTRU 602 switching the primary path of a split bearer to the SL link, the remote WTRU 602 pausing any data transmission over the SL link, and/or the remote WTRU 602 resuming data transmission over the SL link.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶16 or means-plus-function claim format, and any claim without the terms “means for” is not so intended.

1. A remote wireless transmit/receive unit (WTRU), operating in a multipath setting using a direct link (Uu) and a sidelink (SL) via a relay WTRU, comprising:
a processor, a memory, and a transceiver configured to:
receive, from a base station, configuration information for handling of data transmission over the Uu and SL, wherein the configuration information includes information indicating an association of flow control (FC) information with a distribution percentage of data over the Uu and the SL,
receive, from the relay WTRU, FC information,
transmit, based on the distribution percentage associated with the received FC information, data using the Uu and the SL, and
transmit, to the base station, information indicating that transmission behavior of the remote WTRU has been modified.

2. (canceled)

3. The remote WTRU of claim 1, wherein the processor, the memory, and the transceiver are configured to determine the distribution percentage from a set of distribution percentages based on the association with the received FC information, wherein the configuration information includes information indicating a set of FC information in association with the set of distribution percentages.

4. The remote WTRU of claim 1, wherein the configuration information further includes information indicating a scaling factor and a threshold, and
wherein the processor, the memory, and the transceiver are configured to:
transmit the data using the Uu and the SL based on (i) the received FC information being above the threshold, (ii) the distribution percentage associated with the received FC information, and (iii) the distribution percentage modified using the scaling factor.

5. The remote WTRU of claim 1, wherein the configuration information further includes information indicating a threshold, and
wherein the processor, the memory, and the transceiver are configured to:
transmit the data using the Uu and the SL based on (i) the distribution percentage associated with the received FC information, and (ii) a difference between the received FC information and the threshold.

6. The remote WTRU of claim 1, wherein the received FC information includes any of a downlink buffer state of data to be transmitted by the relay WTRU, a rate of change of the downlink buffer state, a downlink data rate at the relay WTRU, an uplink buffer state of data to be transmitted by the relay WTRU, a rate of change of the uplink buffer state, an uplink data rate at the relay WTRU, a latency of a backhaul Uu between the relay WTRU and a base station, radio link information of the backhaul Uu, resource availability of the backhaul Uu, and/or a connection state of the backhaul Uu.

7. The remote WTRU of claim 5, wherein the downlink buffer state is associated with data to be transmitted by the relay WTRU using the SL to the remote WTRU, and/or the uplink buffer state is associated with data to be transmitted by the remote WTRU using the backhaul Uu.

8. (canceled)

9. The remote WTRU of claim 1, wherein the FC information is associated with a cell that serves the remote WTRU and the relay WTRU.

10. (canceled)

11. The remote WTRU of claim 1, wherein the data to be transmitted is associated with a split bearer that is configured for the Uu and the SL, and the Uu is set as a primary path of the split bearer based on the received FC information.

12. (canceled)

13. The remote WTRU of claim 1, wherein the data to be transmitted is associated with a split bearer that is using the Uu and the SL, and the SL is set as a primary path of the split bearer based on the received FC information.

14. The remote WTRU of claim 1, wherein the information indicating that the transmission behavior of the remote WTRU has been modified is included in any of a radio resource control (RRC) message, a medium access control (MAC) control element, a measurement report, or a buffer status report (BSR).

15. A method implemented by a remote wireless transmit/receive unit (WTRU), operating in a multipath setting using a direct link (Uu) and a sidelink (SL) via a relay WTRU, the method comprising:
receiving, from a base station, configuration information for handling of data transmission over the Uu and SL, wherein the configuration information includes information indicating an association of flow control (FC) information with a distribution percentage of data over the Uu and the SL;
receiving, from the relay WTRU, FC information;
transmitting, based on the distribution percentage associated with the received FC information, data using the Uu and the SL; and
transmitting, to the base station, information indicating that transmission behavior of the remote WTRU has been modified.

16. (canceled)

17. The method of claim 15, further comprising:
determining the distribution percentage is from a set of distribution percentages based on the association with the received FC information, wherein the configuration information includes information indicating a set of FC information in association with the set of distribution percentages.

18. The method of claim 15, wherein the configuration information further includes information indicating a scaling factor and a threshold, and
wherein the data is transmitted using the Uu and the SL based on (i) the received FC information being above the threshold, (ii) the distribution percentage associated with the received FC information, and (iii) the distribution percentage modified using the scaling factor.

19. The method of claim 15, wherein the configuration information further includes information indicating a threshold, and
wherein the data is transmitted using the Uu and the SL based on (i) the distribution percentage associated with the received FC information, and (ii) a difference between the received FC information and the threshold.

20. The method of claim 15, wherein the received FC information includes any of a downlink buffer state of data to be transmitted by the relay WTRU, a rate of change of the downlink buffer state, a downlink data rate at the relay WTRU, an uplink buffer state of data to be transmitted by the relay WTRU, a rate of change of the uplink buffer state, an uplink data rate at the relay WTRU, a latency of a backhaul Uu between the relay WTRU and a base station, radio link information of the backhaul Uu, resource availability of the backhaul Uu, and/or a connection state of the backhaul Uu.

21. The method of claim 20, wherein the downlink buffer state is associated with data to be transmitted by the relay WTRU using the SL to the remote WTRU. and/or the uplink buffer state is associated with data to be transmitted by the relay WTRU using the backhaul Uu.

22. (canceled)

23. The method of claim 15, wherein the configuration information is associated with a cell that serves the remote WTRU and the relay WTRU.

24. (canceled)

25. The method of claim 15, wherein the data to be transmitted is associated with a split bearer that is configured for the Uu and the SL, and the Uu is set as a primary path of the split bearer based on the received FC information.

26. (canceled)

27. The method of claim 15, wherein the data to be transmitted is associated with a split bearer that is configured for the Uu and the SL, and the SL is set as a primary path of the split bearer based on the received FC information.

28. The method of claim 15, wherein the information indicating that the transmission behavior of the remote WTRU has been modified is included in any of a radio resource control (RRC) message, a medium access control (MAC) control element, a measurement report, or a buffer status report (BSR).
